(19) United States
(12) Patent Application Publication
(10) Pub. No.: US 2016/0157968 A1
(43) Pub. Date: Jun. 9, 2016

(54) CUSTOMIZED DENTAL IMPLANT PROSTHESIS PRODUCTION METHOD USING CAD/CAM

(71) Applicant: DAESUNG INDUSTRIAL CO., LTD., Guro-gu, Seoul (KR)

(72) Inventors: Jung-Han KIM, Seoul (KR); Kun-Jae KIM, Seoul (KR)

(21) Appl. No.: 14/905,289

(22) PCT Filed: Sep. 6, 2013
(86) PCT No.: PCT/KR2013/008091

§ 371 Date: Jan. 15, 2016

(30) Foreign Application Priority Data
Jul. 18, 2013 (KR) 10-2013-0084649

(51) Int. Cl. A61C 13/00; A61C 13/34

(52) U.S. Cl. CPC A61C 13/0004; A61C 13/34

(57) ABSTRACT

The present invention provides a production method for producing a dental implant prosthesis using CAD/CAM, the dental implant prosthesis production method being characterized by: obtaining a set of three-dimensional shape data on an oral environment and displaying same in a CAD system; obtaining a set of three-dimensional shape data on a dental implant prosthesis from a wax-up model; processing the sets of data so as to derive three-dimensional shape data on a crown and an abutment such that the shape of the inside of the crown is determined depending on the shapes of the chamfer surface and post of the abutment; and producing the crown and the abutment through processing by using the derived three-dimensional shape data on the crown and the abutment.

### TECHNICAL FIELD

The present invention relates to a method for producing a customized dental implant prosthesis. More particularly, the present invention relates to a method for producing a customized dental implant prosthesis using CAD/CAM, which is capable of collectively designing and manufacturing a crown and an abutment using CAD/CAM.

### BACKGROUND ART

Generally, an implant means a substitute that is implanted into a human body to restore a lost human tissue. However, in a dental field, the implant refers to the placement of a dental substitute that is artificially made. That is, the implant means a dental procedure where a dental root made of titanium having no rejection is implanted into the alveolar bone from which the tooth is lost so as to replace the root of the lost tooth, and then an artificial tooth is fixed, thus recovering the function of the tooth.

A common prosthesis or denture is problematic in that the surrounding teeth and bone may be damaged over time. However, a dental implant prosthesis is advantageous in that it does not damage the surrounding tooth tissue, has the same function and shape as the natural tooth, and does not get a cavity, and consequently the implant prosthesis may be used semi-permanently.

Further, the dental implant prosthesis enhances the function of the denture for a patient having a partial- or complete-tooth-free region, in addition to restoring a single missing tooth, and improves aesthetic effect in dental prosthetic restoration. Moreover, this helps distribute excessive stress acting on the tissue of the surrounding support bone and stabilizes a set of teeth.

As such, the procedure for the dental implant prosthesis is composed of a dental surgery process of implanting a fixture into the gum bone, namely, the alveolar bone, and a prosthesis process of connecting an abutment to the implanted fixture to mount a tooth substitute.

The procedure for the dental implant prosthesis may be performed in various manners. One of the methods will be described below. The method of performing the procedure for the dental implant prosthesis that will be described below is fixture level impression wherein an impression coping is connected in the mouth when an impression is taken in the prosthesis process and thereby a model is finished in the mouth.

First, a recess is formed to match the dimension of the fixture after drilling and tapping are performed on the alveolar bone, and a mount is fastened to an upper portion of the fixture. Subsequently, the fixture and the mount are implanted into the alveolar bone using an operating handpiece and then the mount is removed from the fixture, so that the fixture is implanted into the alveolar bone.

Further, a cover screw is fastened to the upper portion of the fixture to suture the fixture. In this way, primary surgery is completed.

The cover screw prevents germs and foreign matter present in the mouth from entering the fixture while the fixture is integrated into the bone. A bone integration period slightly varies depending on an osseous tissue and an implantation position, but generally requires three to six months.

Subsequently, after the gum is opened to expose the cover screw through secondary surgery, a degree to which the fixture is integrated into the bone is checked and the cover screw is removed. Moreover, in order to form the aesthetic gum, a healing abutment is fastened to the upper portion of the fixture, and then two to three weeks are required. Recently, in order to overcome the complexity of such a two-stage procedure, a one-stage procedure is sometimes used by omitting the step of fastening and removing the cover screw and directly fastening the healing abutment.

Next, after checking the formation of the aesthetic gum, the healing abutment is removed, and the impression coping is fastened to the upper portion of the fixture to manufacture the prosthesis. Subsequently, a preliminary impression is taken in the mouth using impression materials, and the impression coping is removed.

Thereafter, after a tooth model is made and an artificial tooth, namely, an artificial crown is processed, the abutment is fastened to the upper portion of the fixture, and an upper prosthesis (i.e. crown) is fixed to the top of the abutment. Thereby, the implant prosthesis is completed.

### DISCLOSURE

### Technical Problem

Accordingly, the present invention is intended to provide a production method, which is capable of designing and manufacturing a crown and an abutment of a dental implant prosthesis using CAD/CAM.

Further, the present invention is intended to provide a production method, which is capable of reducing a time required for a design and a manufacture and improving joining properties of a crown and an abutment, by collectively designing and manufacturing the crown and the abutment of the dental implant prosthesis.

### Technical Solution

In an aspect, the present invention provides a method for producing a dental implant prosthesis using CAD/CAM, the method including obtaining a piece of three-dimensional shape data on an oral environment and displaying the data in a CAD system; obtaining a piece of three-dimensional shape data on a dental implant prosthesis from a wax-up model; processing the pieces of data to derive three-dimensional shape data on a crown and an abutment, the shape of an inside of the crown being determined depending on shapes of a chamfer surface and a post of the abutment; and producing the crown and the abutment through machining based on the derived three-dimensional shape data on the crown and the abutment.

A width of the chamfer surface of the abutment may be 0.6 mm or more, and a maximum angle of the chamfer surface may be 63 degrees or less.

Further, a post angle of the post may be 14 degrees or less, the post may have a tapered shape such that a cross-sectional area thereof is reduced towards a top thereof, and the taper angle may be 4 degrees or more.

Moreover, an outer line of the chamfer surface may form a margin, and a height deviation of the margin may be 1.0 mm or less.

A boundary between the chamfer surface and the post may be rounded with a curvature of 1 R or more.

When processing the three-dimensional shape data on the abutment to derive the shape of the abutment, machining may be carried out such that a maximum value of an angle of the chamfer surface, a minimum value of the width of the chamfer surface, and the post angle of the post may be within preset numerical ranges.

### Advantageous Effects

The present invention is advantageous in that an abutment and a crown of a dental implant prosthesis are collectively designed and manufactured using CAD/CAM, thus shortening a treatment period.

The present invention is advantageous in that the shape of an abutment manufactured individually depending on a dental shape is limited within a certain range, thus reducing a time and efforts required for a design of the abutment shape and thereby improving productivity and reducing production cost thereof.

In addition, the present invention is advantageous in that the limit of an abutment shape reduces a machining error that may occur at the time of being processed by a cutting device, thus leading to an optimal coupling force between an abutment and a crown.

### DESCRIPTION OF DRAWINGS

FIG. 1 is a view schematically illustrating an appearance and an internal structure of a dental implant prosthesis;

FIG. 2 is a view illustrating an external shape of an abutment produced by a method for producing a dental implant prosthesis according to an embodiment of the present invention;

FIG. 3 is a view illustrating main parts of the abutment produced according to the present invention;

FIG. 4 is an enlarged view of portion A encircled in FIG. 3, illustrating an angle of a chamfer surface of a customized abutment made using precision machining according to the present invention; and

FIG. 5 is an enlarged view of portion B encircled in FIG. 3, illustrating a taper curvature of an upper surface of a post of the abutment produced by the method for producing the dental prosthesis according to the present invention.

### MODE FOR INVENTION

Hereinafter, a method for producing a customized dental implant prosthesis using CAD/CAM according to a preferred embodiment of the present invention will be described in detail with reference to the accompanying drawings.

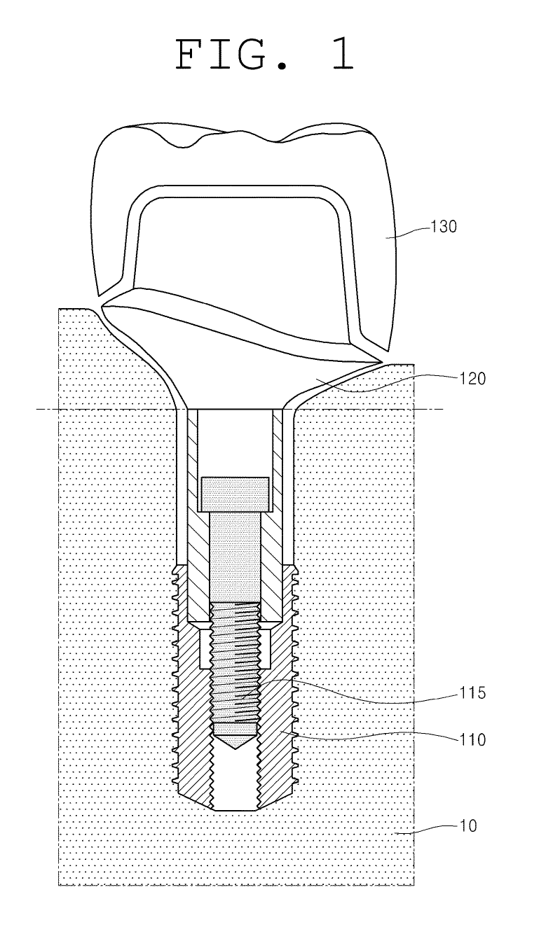

FIG. 1 is a view schematically illustrating an appearance and an internal structure of a dental implant prosthesis.

As shown in the drawing, the dental implant prosthesis includes a fixture 110 inserted into the alveolar bone, an abutment 120 fastened to the fixture, and a crown 130 surrounding the abutment 120 and defining a final appearance of the dental implant prosthesis.

In the drawing, a part under an one-dot-dash line represents a section, while a part above the one-dot-dash line schematically represents a side.

From aesthetic and functional points of view, the crown 130 may be made using various dental materials: for example, the crown may be made of precious metal alloys including gold (Au), non-precious metal or semi-precious metal alloys including no gold, may be made of ceramic materials, or may be made in combination of precious metal, non-precious metal or semi-precious metal and ceramics.

The appearance of the crown 130 is determined using the shape of a patient's extracted tooth, the shape of an opposing tooth occluding the extracted tooth or the like.

Further, an inside of the crown 130 is shaped to correspond to the appearance of the abutment.

The present invention proposes two shapes, that is, a shape formed such that a top of the abutment is formed flat, and a shape formed such that the top of the abutment corresponds to the appearance of the crown.

In the case of forming the top of the abutment flat, machining costs, a machining period, a designing period, and a post-machining period may be reduced. Further, it is possible to decrease the occurrence a non-machined area or an over-machined area during the machining. Consequently, it is possible to produce a relatively cheap distributional product.

In the case of forming the top of the abutment to correspond to the shape of the crown (final dental shape), machining costs and a machining period of the abutment and the crown are increased, but the load distribution effect of the abutment is maximized. Therefore, it is possible to produce a high-quality product having excellent durability.

The crown 130 may be coupled with the abutment 120 by form-fitting or by adhesive force using an adhesive or the like

As described above, the crown 130 is made of a metal including the precious metal or a ceramic material. The larger a volume occupied by the crown 130 is, the higher machining costs and production costs thereof are.

The present invention is intended to provide a method for producing a dental implant prosthesis using CAD/CAM, and is capable of improving joining strength of the crown and the abutment and reducing a time required to manufacture the implant prosthesis, by collectively manufacturing the crown and the abutment.

To this end, the method of the present invention includes obtaining a piece of three-dimensional shape data on a patient's oral environment and displaying the data in a CAD system, preparing a wax-up model in consideration of the shape of surrounding teeth and an occlusion tooth, and obtaining a piece of three-dimensional shape data on a final prosthesis by scanning the wax-up model. The method further includes processing the piece of three-dimensional shape data on the patient's oral environment and the piece of three-dimensional shape data on the final prosthesis to derive three-dimensional shape data on the crown and the abutment.

Preferably, the shape of the inside of the crown is determined depending on shapes of a chamfer surface and a post of the abutment.

The pieces of three-dimensional shape data on the crown and the abutment, which are derived as such, are converted into a piece of data for a CAM (Computer aided manufacturing) process to produce the crown and the abutment through machining.

The method for producing the dental implant prosthesis of the present invention is characterized in that it has several limitations on deriving the shapes of the abutment and the crown.

Here, the several limitations are set to cause the implant prosthesis to fulfill its own function, and may be minimum design requirements for ensuring both the durability and the joining strength.

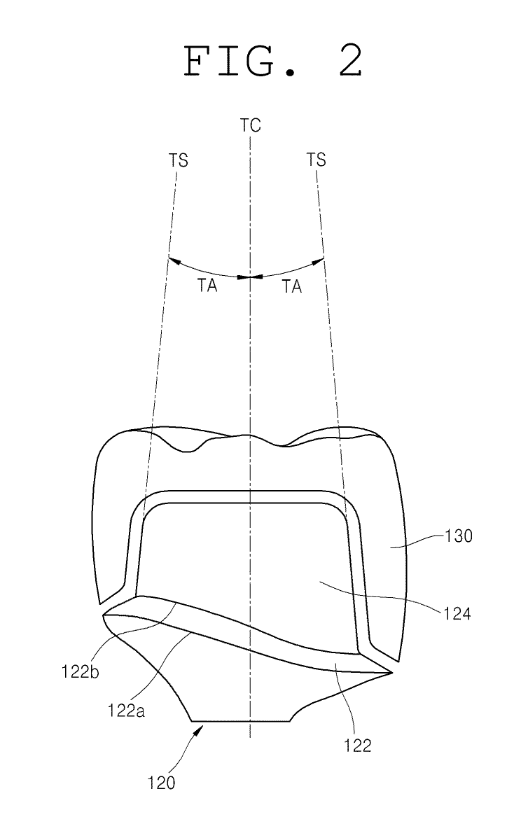

FIG. 2 is a view illustrating the external shape of the abutment produced by the method for producing the dental implant prosthesis according to the embodiment of the present invention.

The abutment 120 includes a part inserted into the gum and a part protruding out of the gum. The part protruding out of the gum is surrounded by the crown 130. The part of the abutment 120 inserted into the gum is shaped to correspond to the shape of the gum and to be fastened to a fixture.

The part of the abutment 120 protruding out of the gum should be easily and firmly coupled with the crown 130.

In producing the dental implant prosthesis having the same shape, if the volume of the abutment 120 increases, the volume of the crown 130 reduces. In contrast, if the volume of the abutment 120 reduces, the volume of the crown 130 increases. As described above, since an increase in volume of the crown 130 is disadvantageous in terms of production cost and workability, it is preferable to possibly increase the volume of the abutment 120. In addition, the abutment 120 is relatively higher in strength than the crown 130. Therefore, if the volume of the abutment 120 is set to match with a minimum thickness that is suitable for the shape of the crown and a normal functional configuration, this is advantageous in terms of strength and durability.

As illustrated in FIG. 2, the abutment 120 includes an annular chamfer surface 122 that is in surface contact with a bottom surface of the crown 130, and a post 124 that protrudes conically from an inside of the chamfer surface 122. Here, the term “annular” means the shape of a closed curve that is wider than a circle and an ellipse.

The chamfer surface 122 is an annular curved surface delimited by a chamfer outer line 122a and a chamfer inner line 122b.

The chamfer outer line 122a is a linear region that is generated by making an outer surface of the abutment contact with the crown that is an upper prosthesis. The chamfer outer line is also referred to as a margin.

The margin may be positioned above or under an imaginary line that is formed by connecting highest points of the gum around the dental implant substitute to each other. The position of the margin may be adjusted by the dentist depending on the dental conditions of individual patients to be under or above a reference line by a few millimeters.

The chamfer surface 122 is connected to the bottom surface of the crown 130 to be in surface contact therewith. The chamfer surface preferably has a predetermined range of width and a predetermined range of angle.

The width of the chamfer surface is preferably 0.6 mm or more. In other words, it is preferable to set the width of the chamfer surface to at least 0.6 mm or more. Further, the maximum angle of the chamfer surface is preferably 63 degrees or less.

If the width and the angle of the chamfer surface are beyond the above-described ranges, it is difficult to attain a coupling strength of the crown with the abutment.

The post 124 has a tapered shape such that a cross-sectional area thereof is reduced towards a top thereof. The reason is as follows: such a configuration allows the crown 130 to be easily coupled with the abutment 120, because the coupling is performed by fitting the crown 130 over the abutment 120 in a direction from top to bottom.

An angle between a central axis TC of the post 124 and a side surface TS of the post is referred to as a taper angle TA. Preferably, the taper angle TA is preferably in the range of 4 to 10 degrees.

If the taper angle TA is less than 4 degrees, an excessive force may be required to fit the crown 130 over the abutment, or the incomplete fitting of the crown 130 may be done.

Meanwhile, if the taper angle TA is more than 10 degrees, the volume occupied by the crown 130 in an upper portion is increased, so that production cost thereof may undesirably rise, and a coupling force with the crown may be lowered.

Further, a post angle that is an angle between the central axis TC of the post 124 and a screw is preferably 14 degrees or less. If the post angle exceeds this range, occlusion pressure is not reliably transmitted to the fixture, thus leading to a deterioration in durability.

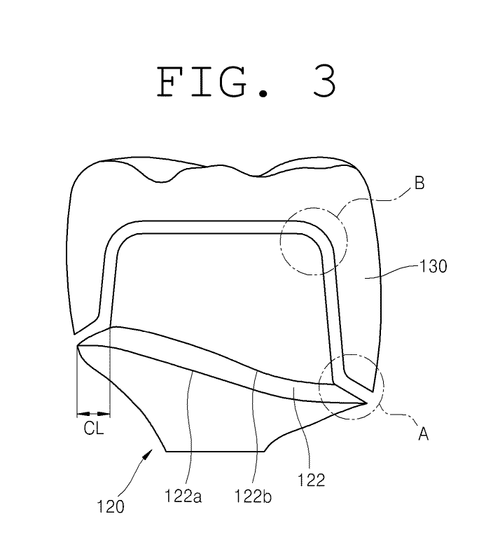

FIG. 3 is a view illustrating main parts of the abutment produced according to the present invention.

FIG. 3 illustrates a distributional product that is reduced in machining period and cost by forming the top of the post flat.

The width and thickness of the chamfer surface 122 delimited by the chamfer outer line 122a and the chamfer inner line 122b are important parameters. The chamfer surface 122 serves to receive a load from the crown and then distribute the load, and has great effect on durability.

The width CL of the chamfer surface 122 means a horizontal distance between the chamfer outer line 122a and the chamfer inner line 122b. A thickness of a lower end of the crown 130 is determined by the width of the chamfer surface 122.

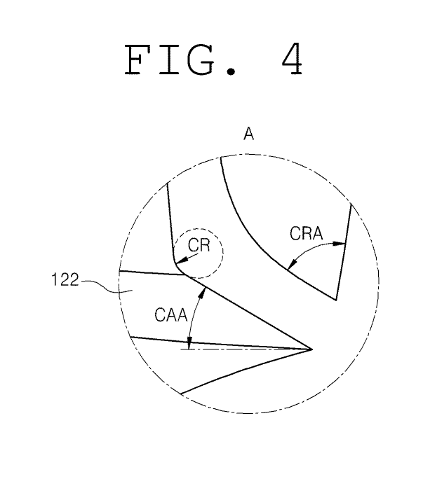

FIG. 4 is an enlarged view of portion A encircled in FIG. 3, illustrating an angle of a chamfer surface of a customized abutment made using precision machining according to the present invention.

An angle CAA of the chamfer surface 122 means an angle between the horizontal surface and the chamfer surface 122. A maximum value of the angle is preferably 63 degrees or less.

A junction between the chamfer surface 122 and the post 124 is preferably formed to have a round shape of a predetermined curvature or more.

A curvature of a boundary surface between the chamfer surface 122 and the post 124 is referred to as a chamfer curvature CR. The setting of the chamfer curvature is very important to prevent the elimination of materials due to over-machining and the occurrence of a non-machined area, when a cutting process is performed using a cutting tool.

The chamfer curvature CR is preferably 1.0 to 1.5 mm or more when the cutting tool having a diameter of 2.0 mm is used. A ratio of the chamfer curvature to the diameter of the cutting tool is preferably in the range of 100% to 150% of a radius of the cutting tool.

If the chamfer curvature is less than the above-mentioned range, the cutting operation may be excessively performed. In contrast, if the chamfer curvature is more than the above-mentioned range, a ratio occupied by the curved surface in the chamfer surface is increased, so that the load of the crown may not be reliably transmitted to the chamfer surface.

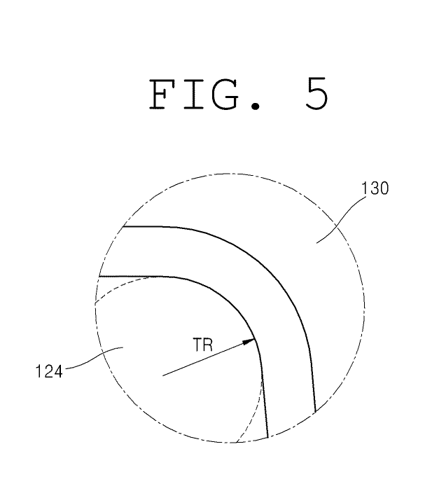

FIG. 5 is an enlarged view of portion B encircled in FIG. 3, illustrating a taper curvature of an upper surface of the post of the abutment produced by the method for producing the dental prosthesis according to the present invention.

The post curvature TR is formed in a corner portion at which the side surface of the post meets the upper surface thereof. Since the crown is coupled to the post, the curvature of a recess formed in the crown is determined depending on the post curvature.

In the case of using the cutting tool having the diameter of 2.0 mm, the post curvature TR is preferably in the range of 1.0 to 1.5 mm.

A ratio of the post curvature to the radius of the cutting tool is in the range of 100 to 150%.

If the post curvature TR is less than the above-described range, the non-machined area may occur at the time of manufacturing the crown that is the upper prosthesis, so that adaptation is poor and thereby additional machining is required. Consequently, marching efficiency is deteriorated.

In contrast, if the post curvature TR is more than the above-described range, the volume of the abutment may be excessively increased or reduced. If the volume of the abutment is too large, it is difficult for the upper prosthesis to have an optimal thickness. In contrast, if the volume of the abutment is too small, a retention force with the upper prosthesis is reduced, and the occlusion pressure is not distributed adequately.

Summarizing the abutment shape according to the present invention, the margin is set by the chamfer outer line such that the height deviation is 1.0 mm or less, the chamfer inner line which is the boundary between the taper and the chamfer surface is set to have the chamfer surface width of 0.6 mm or more in the chamfer outer line and the chamfer surface angle of 63 degrees or less, the post angle of the post is set to 14 degrees or less, and the taper angle of the post is set in the range of 4 to 10 degrees, thus being capable of designing the shape of the three-dimensional abutment.

As described above, the abutment according to the present invention has the shape derived from the appearance of the crown to minimize the volume of the crown volume and have the coupling force with the crown.

1. A method for producing a dental implant prosthesis using CAD/CAM, the method comprising:
obtaining a piece of three-dimensional shape data on an oral environment and displaying the data in a CAD system;
obtaining a piece of three-dimensional shape data on a dental implant prosthesis from a wax-up model;
processing the pieces of data to derive three-dimensional shape data on a crown and an abutment, the shape of an inside of the crown being determined depending on shapes of a chamfer surface and a post of the abutment; and
producing the crown and the abutment through machining based on the derived three-dimensional shape data on the crown and the abutment.

2. The method according to claim 1, wherein a width of the chamfer surface of the abutment is 0.6 mm or more, and
a maximum angle of the chamfer surface is 63 degrees or less.

3. The method according to claim 1, wherein a post angle of the post is 14 degrees or less.

4. The method according to claim 3, wherein the post has a tapered shape such that a cross-sectional area thereof is reduced towards a top thereof, and the taper angle is 4 degrees or more.

5. The method according to claim 1, wherein an outer line of the chamfer surface forms a margin, and a height deviation of the margin is 1.0 mm or less.

6. The method according to claim 1, wherein a boundary between the chamfer surface and the post is rounded with a curvature of 1 R or more.

7. The method according to claim 1, wherein, when processing the three-dimensional shape data on the abutment to derive the shape of the abutment, machining is carried out such that a maximum value of an angle of the chamfer surface, a minimum value of the width of the chamfer surface, and the post angle of the post are within preset numerical ranges.
